(19) United States
(12) Patent Application Publication
(10) Pub. No.: US 2015/0377405 A1
(43) Pub. Date: Dec. 31, 2015

(54) INSPECTION SYSTEMS

(71) Applicant: Pearson Engineering Ltd, Newcastle-upon-Tyne (GB)

(72) Inventors: Chris Down, Newcastle-upon-Tyne (GB); Neil Armstrong, Rowlands Gill (GB); James Cross, Blaydon on Tyne (GB)

(73) Assignee: PEARSON ENGINEERING LTD, Newcastle-upon-Tyne (UK)

(21) Appl. No.: 14/750,409

(22) Filed: Jun. 25, 2015

(30) Foreign Application Priority Data
Jun. 25, 2014 (GB) 1411293.2

(51) Int. Cl. F16L 55/30; B64D 47/08; F16L 55/40; G05D 1/00; B64C 17/00; B64C 17/06; B64C 39/02; B64C 27/04

(52) U.S. Cl. CPC F16L 55/30; B64C 39/024; B64D 47/08; B64C 27/04; G05D 1/0011; G05D 1/0027; B64C 17/00; B64C 17/06; F16L 55/40; B64C 2201/123; B64C 2201/127; B64C 2201/146; B64C 2201/024

(57) ABSTRACT

There is provided a stabilisation system for an unmanned aerial vehicle (UAV) comprising positional stabilizer. A UAV provided with a stabilisation system, a method of stabilising a UAV and an inspection method are also provided.

The present invention relates generally to inspection systems for inspecting and/or surveying and/or monitoring internal and/or external areas of interest.

The present invention may be applicable, for example, to surveying conduits. The term “conduit” includes culverts, pipes, sewers, drains and tunnels.

For example, military patrols need to make painstaking investigations of conduits that traverse their route. These surveys are very time consuming and place the static patrol at risk from attack. No remote surveying method is known for surveying conduits with a view to identifying potential presence of explosives and improvised explosive devices.

According to an aspect of the present invention there is provided an inspection system comprising a parent unmanned aerial vehicle (PUAV) and a child unmanned aerial vehicle (CUAV), the PUAV having inspection means, the CUAV being carried on or by, and being deployable from, the PUAV and also having inspection means.

By using a PUAV and a CUAV, a shorter required range for the CUAV means that less of the payload is consumed by batteries, thereby leaving more available for inspection equipment.

The system may be configured for: inspecting a culvert and declaring it either safe or unsafe to cross; and/or inspecting a Named Area of Interest (NAI) around the culvert for suspicious objects.

Some systems are therefore based around a large Parent UAV (PUAV) with two separate payloads: one for culvert inspection and one for NAI inspection.

The present invention may provide a delivery system that has the capability to position new and existing sensor technologies where they are needed for the remote inspection of culverts.

There is no global standard for culverts which means that their shape, size, length, level of obstruction and surrounding terrain are variable, so the system may be adaptable for a variety of circumstances.

NAI inspection may comprise some high level photography/mapping followed by detailed inspection of specified areas.

Some systems formed in accordance with the present invention include three stages: transporting a camera to the culvert entrance, inserting it through the grate (many culverts are fitted with anti-tamper grates) and controlling the camera through the culvert. These systems therefore work by splitting the culvert inspection task up.

The PUAV and/or CUAV inspection means (e.g., inspection apparatus) may comprise one or more of: a camera; a daylight camera; a low-light camera; a thermal imaging camera; a night vision camera; an infrared camera.

For example the system may use high definition day-light cameras for detailed and general inspection during daylight. The PAUV may have a low-light camera (for example with IR illumination) for general inspection of the NAI at night. The CUAV may have a white light source for detailed inspection in low light conditions.

The PUAV and/or CUAV inspection means (e.g., inspection apparatus) may comprise one or more of: a chemical detector; a metal detector; a wire detector; an acoustic detector; a detector.

The PUAV and/or CUAV may be fitted with a first person view camera.

The PUAV and/or CUAV inspection means (e.g., inspection apparatus) may comprise illumination means (e.g., an illumination apparatus such as a lamp).

The PUAV and/or CUAV may have autonomous and/or semi-autonomous and/or manual flight operation modes.

The PUAV and CUAV may be able to communicate with each other when the CUAV is docked on the PUAV and/or after it has been deployed. For example the PUAV may used as a relay station to communicate between a base station and the CUAV to minimise power requirements for the CUAV.

The PUAV may have an autonomous position hold mode. This could be used, for example, after deployment of the CUAV to allow the pilot to focus on the CUAV.

The system may further comprise means for inserting the CUAV into, and retrieving it from, an inspection target. The inspection target may be a culvert with an entrance grate.

The present invention also provides a culvert inspection system comprising a system as described herein.

The present invention also provides a UAV comprising two or more rotors, in which the rotors are mounted in-line along a longitudinal axis.

The present invention also provides a UAV comprising a gimbal-mounted rotor assembly.

The gimbal-mounting may be free or driven.

The present invention also provides a UAV comprising a rotor assembly having blades, the assembly having cyclical blade pitch control.

The present invention also provides a UAV comprising a rotor assembly having blades, in which the swept diameter is in the range of 100 mm to 300 mm.

In some embodiments the UAV can be folded up prior to insertion, thereby maximising the ratio of the inspection package size to the culvert/grid dimension. This may lead to a larger, more efficient rotor/s.

The present invention also provides a UAV comprising one or more rotors mounted on a body, in which the body is movable between a deployed position and a collapsed position.

The present invention also provides a UAV comprising a chassis on which is mounted one or more rotors, and a cage, frame or the like carried on or by the chassis within which the rotor blades rotate.

The rotor/s may be gimbal-mounted on the chassis.

The cage, frame or the like may be collapsible.

The cage may be adapted to contact a culvert roof whereby to increase stability of the UAV.

The cage may be adapted to increase rotor lift efficiency.

The rotor blades may be foldable.

It may be possible for the rotor blades to be aligned generally longitudinally.

The UAV described herein may be used as the CUAV in the system described herein.

The present invention also provides a method of inspecting a culvert with a UAV, comprising the steps of: deploying a UAV to the entrance of a culvert in a collapsed configuration; inserting the collapsed UAV into a culvert; moving the UAV to a working configuration; and moving the UAV along the culvert.

The method described herein may use a UAV as described herein.

The present invention also provides a stabilisation system for a UAV comprising positional stabilisation means (e.g., a positional stabilizer).

The positional stabilisation means may comprise optical stabilisation means.

The positional stabilisation means may comprise a 1-, 2- or 3-axis video feed.

The positional stabilisation means may comprise one or more cameras.

The stabilisation system may further comprise gyroscopic stabilisation means.

The stabilisation system may further comprise an altimeter.

The stabilisation system may further comprise location means, e.g., a locator, such as GPS.

The present invention also provides a UAV as described herein fitted with a stabilisation system as described herein.

The present invention also provides a method of stabilising a UAV, comprising the steps of: providing one or more optical sensors for detecting one or more points on interest; matching points of interest between consecutive images; and calculating the transformation matrix that represents the change in sensor position/ orientation that would map the consecutive sets of points of interest into each other.

The method may further comprise the step of tracking the points of interest while they remain within the field of view of the sensor/s to enable it to maintain an absolute positional reference.

Further embodiments are disclosed in the dependent claims attached hereto.

Different aspects and embodiments of the invention may be used separately or together.

Further particular and preferred aspects of the present invention are set out in the accompanying independent and dependent claims.

Features of the dependent claims may be combined with the features of the independent claims as appropriate, and in combination other than those explicitly set out in the claims.

The present invention will now be more particularly described, by way of example, with reference to the accompanying drawings, in which:

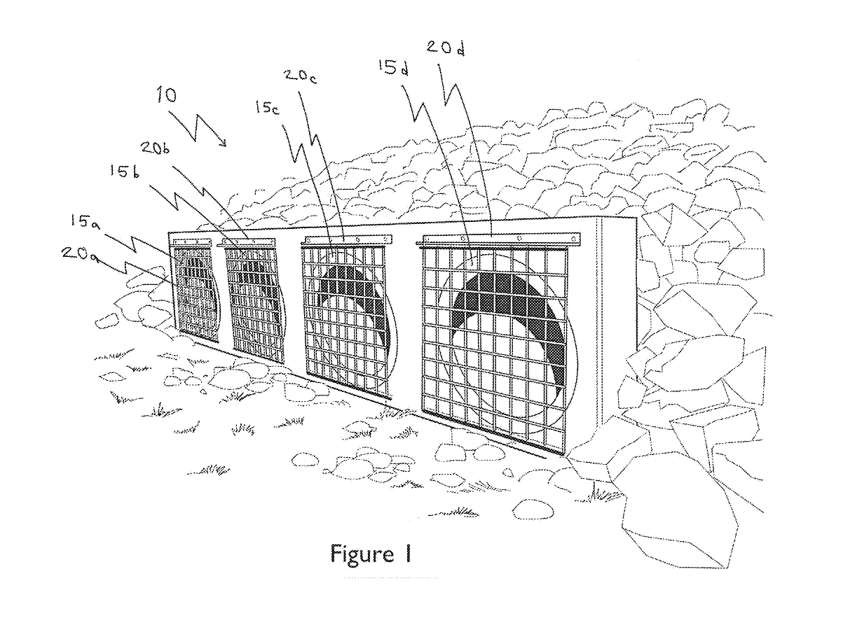

FIG. 1 shows multiple culverts in one NAI with anti-tamper grates;

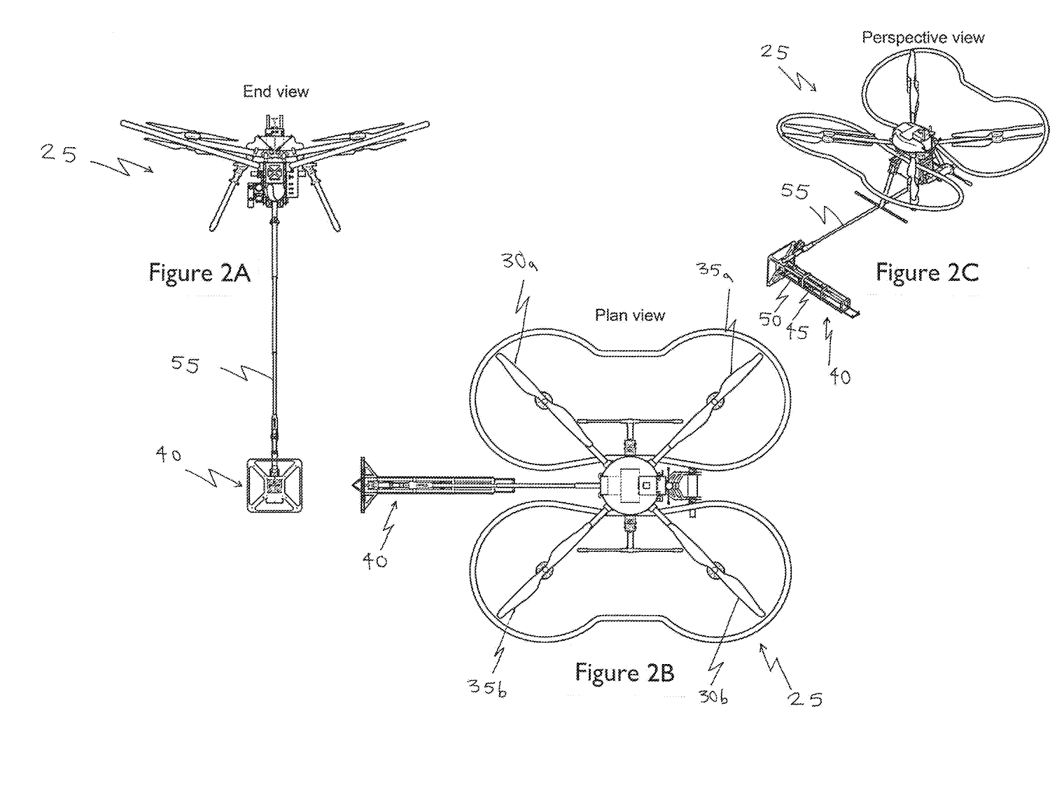

FIGS. 2A, 2B and 2C show end, plan and perspective views of a PUAV carrying a CUAV, upon which inspection systems of the present invention may be based;

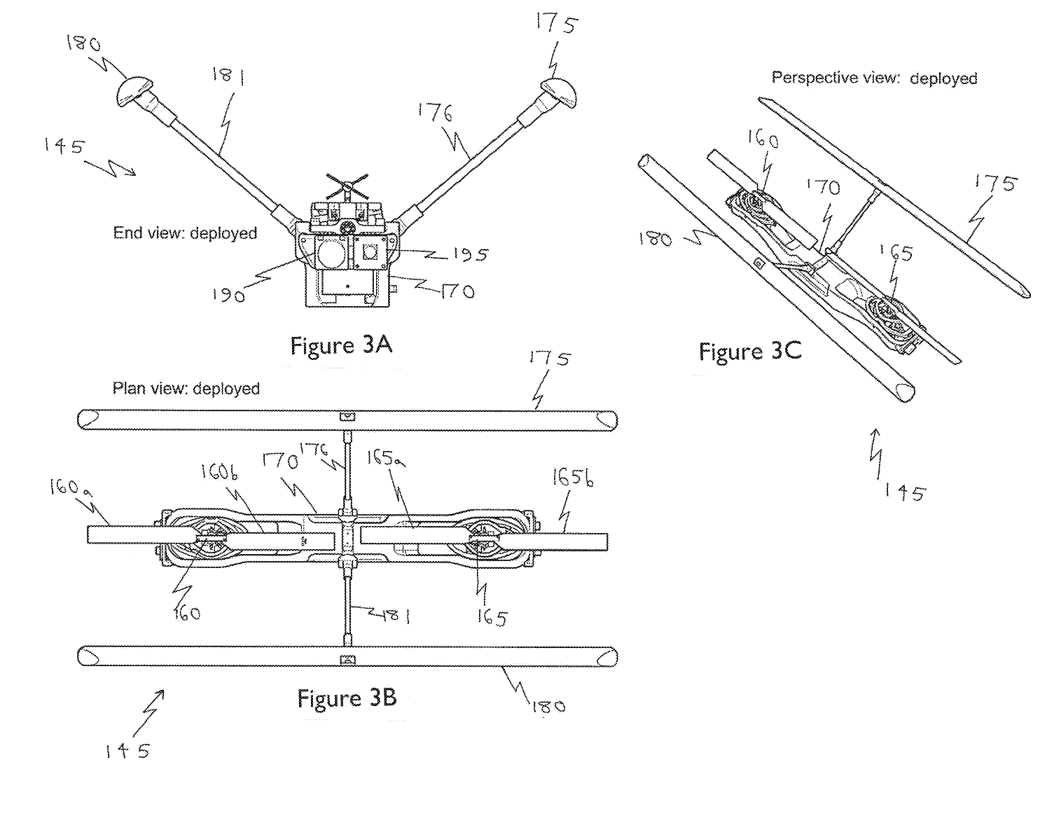

FIGS. 3A, 3B and 3C show plan, end and perspective views of a UAV formed according to the present invention and shown in a deployed configuration;

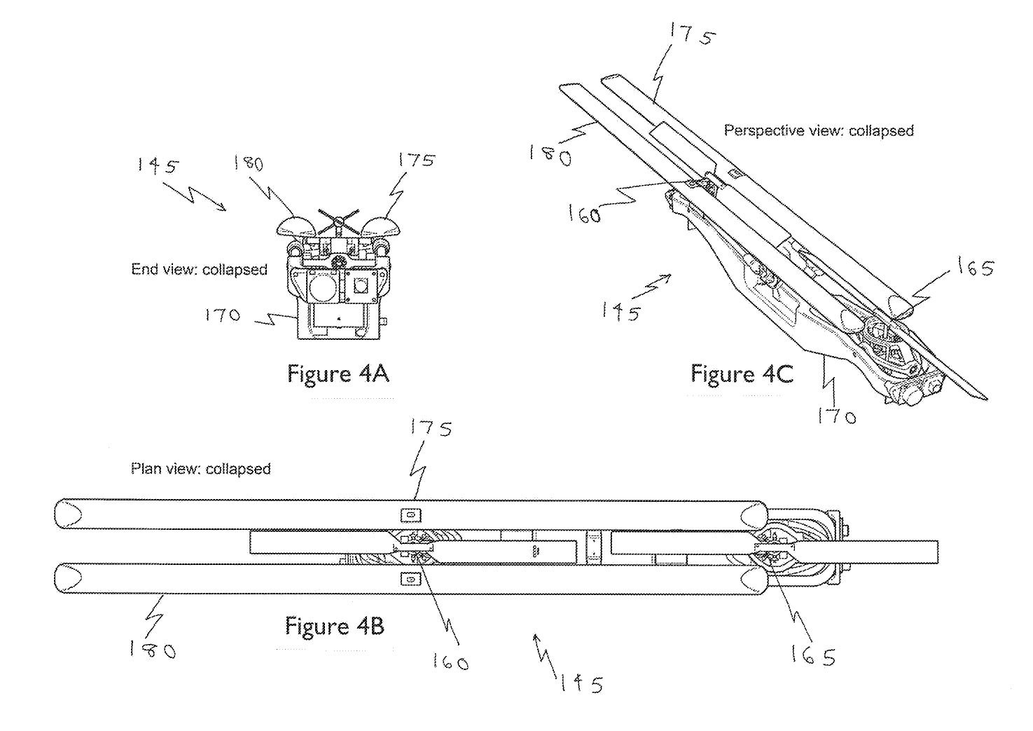

FIGS. 4A, 4B and 4C show corresponding plan, end and perspective views of the UAV of FIG. 3 shown in a collapsed configuration; and

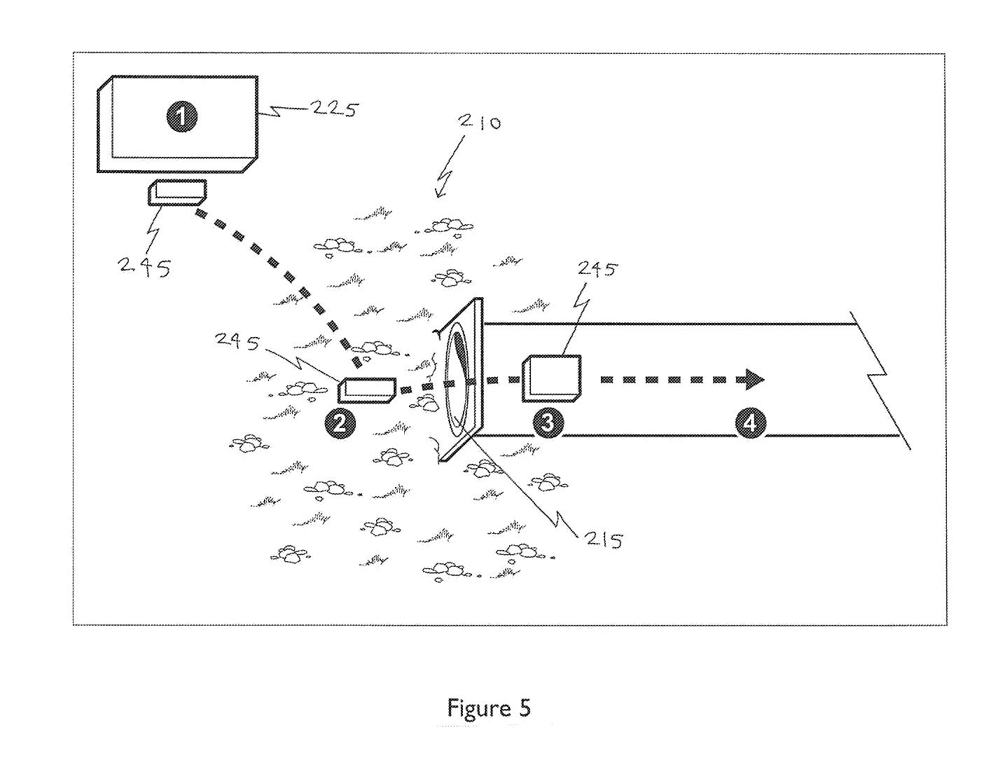

FIG. 5 is a schematic illustration of an inspection system formed in accordance with the present invention.

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

In FIG. 1 there is shown a NAI 10 with multiple culverts 15a, 15b, 15c, 15d each having an anti-tamper gate 20a, 20b, 20c, 20d.

In FIG. 2 an example of a PUAV/CUAV inspection system is shown.

A parent unmanned aerial vehicle (PUAV) or drone 25 is provided, which in this embodiment is an aircraft without a human pilot aboard. The PUAV may be a remote controlled aircraft (e.g. flown by a pilot at a ground control station) or in some embodiments can fly autonomously based on pre-programmed flight plans or more complex dynamic automation systems.

In this embodiment the PUAV 25 is a quadcopter, also called a quadrotor helicopter i.e. a multirotor helicopter that is lifted and propelled by four rotors.

In this embodiment the PUAV is a rotorcraft, more specifically a rotor-driven quad-copter aircraft.

In this embodiment the PUAV 25 use two sets of identical fixed pitched twin-blade propeller units: two clockwise (CW) 30a, 30b; and two counter-clockwise (CCW) 35a, 35b. These use variation of RPM to control lift and torque.

The rotors are aligned in a square, two on opposite sides of the square rotate in a clockwise direction and the other two rotate in the opposite direction. Control of vehicle motion is achieved by altering the rotation rate of one or more rotor discs, thereby changing its torque load and thrust/lift characteristics.

The PUAV may have four controllable degrees of freedom: Yaw, Roll, Pitch, and Altitude. Each degree of freedom can be controlled by adjusting the thrusts of each rotor.

The PUAV 25 carries a CUAV unit 40 which comprises a CUAV 45 and an insertion mechanism 50.

The CUAV unit 40 is detachably attached to the PUAV 25 by a tether 55.

In some embodiments the PUAV has a NAI inspection payload and a culvert inspection payload:
Parent UAV (PUAV): FPV day camera, night camera and IR light (collision avoidance)
Culvert Inspection Payload: Child UAV (CUAV) with white light source and daylight camera. Insertion Mechanism
NAI Inspection Payload: Daylight & low light cameras (downward looking); white light & IR light source (downward looking)

An example of the type of PUAV which may be used as part of the present invention is the md4-1000 produced by Microdrones GmbH.

An example of an inspection plan is as follows. On receipt of the relevant map, the data is uploaded to the base-station software. This will then allow the operator to mark each culvert as a way point as well as plotting a specific path to/from each culvert if obstacle avoidance is necessary. The operator will then mark the NAI and select an appropriate search pattern for the initial high-level inspection.

The PUAV will then fly to each culvert semi-autonomously—once the PUAV has arrived at the culvert, the PUAV will be manually operated.

The PUAV is permanently fitted with a First Person View (FPV) day and night camera, with IR illumination to aid with obstacle avoidance.

To minimise the payload carried by the CUAV, its communication range is limited to only 100 ft—the PUAV is used as a relay station to communicate between the base station and CUAV.

The operator only needs to control the speed of flight—the auto-pilot keeps the PUAV on the correct path. At any point, the operator can take over manual operation to negotiate any unexpected obstacles.

Culvert Inspection

The culvert inspection payload 40 comprises CUAV 45 and a mechanism 50 for inserting it into, and/or retrieving it from, the culvert.

Once the CUAV 45 is inside the culvert, the PUAV 25 will go into ‘position hold’ mode (using GPS) outside the culvert. Whilst the PUAV is holding position autonomously, the operator is free to pilot the CUAV along the culvert. The CUAV have some/all of a number of features discussed below that allow it to be safely and reliably controlled inside the confined space of the culvert.

In FIGS. 3 and 4 a UAV 145 (which may be a CUAV) is shown. The UAV may have some/all of the following features.

Multiple, In-line Rotor Blades

In order for the CUAV to fit through the smallest grate aperture possible yet still lift the required payload, it is equipped with multiple rotors (in this embodiment two rotors 160, 165 each with two blades 160a, 160b, 165a, 165b), mounted in-line, along its longitudinal axis.

In order for these rotors to provide full 6 axis control (x, y, z, roll, pitch and yaw), each rotor assembly is freely gimballed and has helicopter style cyclical blade pitch control. Gimbal mounting allows for the rotor assemblies to be protected by a cage.

Large Rotor Diameter

The rotor blades are configured in such a way that they can fold back when being passed through a culvert grate. This maximises the rotor diameter when in operation. A large rotor does not need to rotate as fast as a small one (for a given payload) and hence is more efficient and will generate less blown dust.

Cage and Payload Chassis

The rotor assemblies 160, 165 are gimbal mounted in a narrow chassis 170 that is fitted with a collapsible cage/frame which in this embodiment includes two stabilising “outrigger” type members 175, 180 carried on arms 176, 181 so as to extend laterally and upwardly from the chassis in use. The cage can reduce in size (see FIGS. 4A-4C) when being inserted through a small grate aperture but then expand (see FIGS. 3A-3C) once the CUAV is within the culvert so that the outriggers 175, 180 protect the CUAV if it comes into contact with culvert walls or roof.

‘Ground Effect’ Efficiency

Rotor lift efficiency is increased when it is in proximity to a surface that is roughly perpendicular to its axis of rotation. The CUAV's cage is especially adapted to maximise this increase in lift when it is driven up against the roof. In addition, the cage is designed to contact a curved or flat culvert roof in such a way as to increase the stability of the CUAV when subjected to transient loads such as gusts of wind.

Optical Stabilisation

As a minimum, all UAVs use 3-axis gyroscopic stabilisation to minimise unwanted roll, pitch and yaw movements. More advanced systems use 6-axis (+3x accelerometers) or 9-axis (+3-axis magnetometers) stabilisation. However, for positional stabilisation (i.e. hover) additional sensor information is required—typically GPS is used.

For basic stabilisation, the CUAV uses 6-axis stabilisation techniques. For positional stability, a 3-axis video feed is analysed using image processing algorithms and is overlaid on the gyroscopic sensor data using a Kalman filter.

This results in a simple user interface where the operator only has to command the CUAV to increment its position in a particular direction.

The CUAV includes a daylight camera. The operator will rely on this visual feedback to detect IEDs, obstructions and the like. In some embodiments this camera is capable of being tilted along the axis of the CUAV to allow objects to be identified from either side without turning the CUAV.

Once the CUAV has inspected the inside of the culvert, it will be piloted back to the culvert entrance and land on the bottom of the culvert. The CUAV has positive buoyancy and is electrically protected, to allow it to be landed on water. The PUAV will then autonomously retrace its steps to the base station. If additional culverts need inspecting, a new culvert inspection payload will be fitted, otherwise, the NAI inspection payload is fitted. All CUAVs can be manually retrieved from the culverts when inspection is complete.

NAI Inspection

The NAI Inspection payload includes both day and low-light cameras, pointing directly at the ground which is being scanned—the video feed can be switched between camera sources during operation. When there is sufficient light, the daylight camera is used to conduct a high-level search of the NAI (from approximately 3 m above ground). If there is insufficient ambient light, the low-light camera is used in conjunction with 15W LED IR illumination.

The initial high-level search is conducted semi-autonomously—the PUAV automatically navigates along the pre-determined flight path while the operator controls the flight speed. The PUAV is permanently fitted with an independent day and low light camera (with IR illumination). This camera feed is provided to the operator as a secondary feed. The secondary feed is monitored by visual obstacle avoidance software. This software will automatically alert the operator of approaching objects that lie within the planned flight path, that require intervention.

During the search, the operator can use the base station software to ‘bookmark’ suspicious objects. After the initial high-level search is complete, the software allows the operator to review all images including the bookmarked objects.

If there is insufficient detail in the images obtained, additional detailed inspections can be carried out. The PUAV can autonomously move to hover over each suspicious object and then be manually controlled by the operator to obtain the required views. The day-light camera can be used (with a 30W LED white-light illumination if necessary) to obtain more detailed images.

The use of IR illumination minimises the power consumption for a given level of image clarity.

UAV Positional Stabilisation

There is existing documentation of UAVs that use Optical Flow sensors to aid positional stabilisation. Optical flow sensors detect the rate of motion of the sensor relative to objects in its field of view—i.e. the ‘flow’ rate of pixels across the sensor surface. However, the output of these sensors is a rate of motion which needs to be integrated to obtain positional information. Additionally, the output is only a 2D vector whereas the UAV has the freedom to move in a 3D world where the sensors field of view can be influenced not only by translation in 3 axes but also rotation that can only be fully defined by a further 3 variables (Euler angles).

The present invention includes a method and an algorithm that:
1. Matches points of interest (POI) between consecutive images;
2. Calculates the transformation matrix that represents the change in sensor position/orientation that would map the two sets of POIs onto each other; and
3. Tracks the POIs while they remain within the field of view of the sensor to enable it to maintain an absolute positional reference.

The present invention also contemplates ways to improve the method/algorithm as supplied above:

1. The algorithm as described above will not be very sensitive to translations perpendicular to the camera sensor's surface. By expanding the UAV's Field Of View (FOV) (e.g. using a wide-angle lens, or adding additional sensors at other angles) the sensitivity to translation in all directions can be increased. An ideal (if expensive) solution would be full 360 (spherical) view.
2. Increasing the UAV's FOV allows for redundancy—i.e. if a camera sensor with only a narrow FOV is facing a blank surface, then there won't be any features to use as references. By increasing the FOV, the chance that the UAV will be able to reference sufficient features is increased.
3. If multiple camera sensors are used, and if they have overlapping FOVs, the position of POIs in the overlapping FOVs can be calculated in a single snapshot (by taking advantage of knowledge about the relative positions of the two camera sensors). This would allow for adjustments to the original algorithm that would increase both speed and accuracy.
4. The original algorithm solves 6 unknowns at each step—3 axes of translation and 3 angles of rotation. By introducing an Inertial Measurement Unit (IMU) (at least 3-axis gyroscopes but potentially also 3-axis accelerometers and/or 3-axis magnetometers i.e. compasses), the 3 angles of rotation in consecutive video frames can be more easily calculated and fed into the original algorithm such that only the 3D translation needs to be calculated. This reduces (from 6 to 3) the number of unknowns and would increase the speed of the algorithm.
5. Once we have an IMU onboard the UAV, the output from the IMU can be used to directly control the attitude of the (roll, pitch and yaw) UAV—the optical stabilisation need only be used to measure position.
6. Alternatively to 4 and 5, the IMU data as well as the optical data could be combined using a Kalman Filter to produce a single measurement for all 6 degrees of freedom.

The present invention also provides an optical stabilisation algorithm.

The algorithm may use gyroscope and/or accelerometer and/or magnetometer data to directly measure changes in angle between consecutive video frames. As this reduces (from 6 to 3) the number of unknowns that need to be calculated in the algorithm it will be less computationally expensive and in some instances more accurate.

In FIG. 5 a schematic illustration shows how a PUAV/CUAV system might function.

In step 1 a PUAV 225 arrives in the vicinity of a NAI 210. A CUAV 245 is delivered to the entrance of a culvert 215 in the NAI in a collapsed form in step 2. In step 3 the CUAV 245 has passed through the entrance and transformed into a deployed form so that investigation of the culvert can be conducted (step 4).

Further aspects and embodiments of the present invention are defined in the following paragraphs.
1. An inspection system comprising a parent unmanned aerial vehicle (PUAV) and a child unmanned aerial vehicle (CUAV), the PUAV having inspection means, the CUAV being carried on or by, and being deployable from, the PUAV and also having inspection means.
2. A system as described in paragraph 1, in which the PUAV inspection means is suitable for inspecting a named area of interest.
3. A system as described in paragraph 1 or paragraph 2, in which the CUAV inspection means is suitable for inspecting: a conduit or a confined space.
4. A system as described in any preceding paragraph, in which the PUAV and/or CUAV inspection means comprises one or more of: a camera; a daylight camera; a low-light camera; a thermal imaging camera; a night vision camera; an infrared camera.
5. A system as described in any preceding paragraph, in which the PUAV and/or CUAV inspection means comprises one or more of: a chemical detector; a metal detector; a wire detector; an acoustic detector; a detector.
6. A system as described in any preceding paragraph, in which the PUAV and/or CUAV is fitted with a first person view camera.
7. A system as described in any preceding paragraph, in which the PUAV and/or CUAV inspection means comprises illumination means.
8. A system as described in any preceding paragraph, in which the PUAV and/or CUAV have autonomous and/or semi-autonomous and/or manual flight operation modes.
9. A system as described in any preceding paragraph, in which the PUAV and CUAV can communicate with each other.
10.A system as described in paragraph 9, in which the PUAV is used as a relay station to communicate between a base station and the CUAV.
11.A system as described in any preceding paragraph, in which the PUAV has an autonomous position hold mode.
12.A system as described in paragraph 11, in which the position hold mode can be activated when the CUAV is deployed.
13.A system as described in any preceding paragraph, further comprising means for inserting the CUAV into, and retrieving it from, an inspection target.
14.A system as described in paragraph 13, in which the inspection target is a culvert with an entrance grate.
15.A system substantially as hereinbefore described with reference to, and as shown in, the accompanying drawings.
16.A culvert inspection system comprising a system as described in any preceding paragraph.
17.A UAV comprising two or more rotors, in which the rotors are mounted in-line along a longitudinal axis.
18.A UAV comprising a gimbal-mounted rotor assembly.
19.A UAV as described in paragraph 18, in which the gimbal-mounting is free.
20.A UAV as described in paragraph 18, in which the gimbal-mounting is driven.
21.A UAV comprising a rotor assembly having blades, the assembly having cyclical blade pitch control.
22.A UAV comprising a rotor assembly having blades, in which the swept diameter is in the range of 100 mm to 300 mm.
23.A UAV comprising one or more rotors mounted on a body, in which the body is movable between a deployed position and a collapsed position.
24.A UAV comprising a chassis on which is mounted one or more rotors, and a cage, frame or the like carried on or by the chassis within which the rotor blades rotate.
25.A UAV as described in paragraph 24, in which the rotor/s are gimbal-mounted on the chassis.
26.A UAV as described in paragraph 24 or paragraph 25, in which the cage, frame or the like is collapsible.
27.A UAV as described in any of paragraphs 24 to 26, in which the cage is adapted to contact a culvert roof whereby to increase stability of the UAV
28.A UAV as described in any of paragraphs 24 to 27, in which the cage is adapted to increase rotor lift efficiency.
29.A UAV as described in any of paragraphs 17 to 28, in which the rotor blades are foldable.
30.A UAV as described in any of paragraphs 17 to 29, in which the rotor blades can be aligned generally longitudinally.
31.A UAV as described in any of paragraphs 17 to 30 used as the CUAV in the system of any of claims 1 to 16.
32.A UAV substantially as hereinbefore described with reference to, and as shown in, the accompanying drawings.
33.A method of inspecting a culvert with a UAV, comprising the steps of: deploying a UAV to the entrance of a culvert in a collapsed configuration; inserting the collapsed UAV into a culvert; moving the UAV to a working configuration; and moving the UAV along the culvert.
34.A method substantially as hereinbefore described with reference to, and as shown in, the accompanying drawings.
35.The method of paragraph 33 or paragraph 34 using a UAV as described in any of claims 17 to 32.
36.A stabilisation system for a UAV comprising positional stabilisation means.
37.A system as described in paragraph 36, in which the positional stabilisation means comprises optical stabilisation means.
38.A system as described in paragraph 36 or paragraph 37, in which the positional stabilisation means comprises a 1-, 2- or 3-axis video feed.
39.A system as described in any of paragraphs 36 to 38, in which the positional stabilisation means comprises one or more cameras.
40.A stabilisation system as described in any of paragraphs 36 to 39 further comprising gyroscopic stabilisation means.
41.A system as described in any of paragraphs 36 to 40, further comprising an altimeter.
42.A system as described in any of paragraphs 36 to 41, further comprising a locator.
43.A system substantially as hereinbefore described with reference to, and as shown in, the accompanying drawings.
44.UAV as described in any of paragraphs 17 to 32 fitted with a system as described in any of claims 36 to 43.
45.A method of stabilising a UAV, comprising the steps of: providing one or more optical sensors for detecting one or more points on interest; matching points of interest between consecutive images; and calculating the transformation matrix that represents the change in sensor position/ orientation that would map the consecutive sets of points of interest into each other.
46.A method as described in paragraph 45, further comprising the step of tracking the points of interest while they remain within the field of view of the sensor/s to enable it to maintain an absolute positional reference.
47.A method as described in paragraph 45 or paragraph 46, further comprising the step of measuring changes in angle between consecutive video frames.
48.A method as described in paragraph 47, in which data for measuring the change in angle is provided, by a gyroscope and/or an accelerometer and/or a magnetometer.
49.An algorithm for use in the method of any of paragraphs 45 to 48.
50.An algorithm substantially as described herein.
51.An optical stabilisation algorithm substantially as described herein.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A stabilisation system for an unmanned aerial vehicle (UAV) comprising positional stabilizer.

2. The system of claim 1, wherein the positional stabilizer comprises an optical stabilizer.

3. The system of claim 1, wherein the positional stabilizer comprises a 1-, 2- or 3-axis video feed.

4. The system of claim 1, wherein the positional stabilizer comprises one or more cameras.

5. The system of claim 1, further comprising gyroscopic stabilizer.

6. The system of claim 1, further comprising an altimeter.

7. The system of claim 1, further comprising a locator.

8. The system of claim 1, further comprising a UAV, wherein the system is fitted to the UAV.

9. A method of stabilising a UAV, comprising the steps of: providing one or more optical sensors for detecting one or more points on interest; matching points of interest between consecutive images; and calculating the transformation matrix that represents the change in sensor position/ orientation that would map the consecutive sets of points of interest into each other.

10. The method of claim 9, further comprising the step of tracking the points of interest while they remain within the field of view of the sensor/s to enable it to maintain an absolute positional reference.

11. The method of claim 9, further comprising the step of measuring changes in angle between consecutive video frames.

12. The method of claim 11, in which data for measuring the change in angle is provided, by a gyroscope and/or an accelerometer and/or a magnetometer.

13. An inspection system comprising a parent unmanned aerial vehicle (PUAV) and a child unmanned aerial vehicle (CUAV) comprising a UAV as claimed in claim 8, the PUAV having an inspection apparatus, the CUAV being carried on or by, and being deployable from, the PUAV and also having an inspection apparatus.

14. A method of inspecting a culvert with the UAV of claim 8, comprising the steps of: deploying the UAV to the entrance of a culvert in a collapsed configuration; inserting the collapsed UAV into a culvert; moving the UAV to a working configuration; and moving the UAV along the culvert.
